(19) United States
(12) Patent Application Publication
(10) Pub. No.: US 2023/0276814 A1
(43) Pub. Date: Sep. 7, 2023

(54) GLUTEN FREE PIZZA CRUST AND METHOD

(71) Applicant: Dennis Arthur Lonergan, Long Lake, MN (US)

(72) Inventor: Dennis Arthur Lonergan, Long Lake, MN (US)

(21) Appl. No.: 18/316,412

(22) Filed: May 12, 2023

Related U.S. Application Data
(62) Division of application No. 15/458,491, filed on Mar. 14, 2017.
(60) Provisional application No. 62/312,489, filed on Mar. 24, 2016.

(51) Int. Cl. A21D 13/066; A21D 13/43; A21D 13/41; A21D 10/04; A21D 13/42

(52) U.S. Cl. CPC A21D 13/066; A21D 13/43; A21D 13/41; A21D 10/04; A21D 13/42

(57) ABSTRACT

A cooked, bread like product is provided. The product is formed initially as a pourable batter that has an increasing consistency with time, effected by the use of a fast acting hydrocolloid in combination with a slow acting hydrocolloid and proofing. The cooked product can be used in combination with a topping to form a product like a pizza.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Nonprovisional patent application Ser. No. 15/458,491, entitled “GLUTEN FREE PIZZA CRUST AND METHOD”, filed Mar. 14, 2017, which claims priority to U.S. Provisional Patent Application No. 62/312,489, entitled “GLUTEN FREE PIZZA CRUST AND METHOD”, filed Mar. 24, 2016. The contents of which the above referenced applications are incorporated herein by reference in their entirety.

### FIELD OF THE INVENTION

A bread like product such as a crust for use in making pizza or the like is provided. The product is gluten-free.

### BACKGROUND OF THE INVENTION

It is well known in the art that many people have a sensitivity to the ingestion and digestion of gluten containing food products. Gluten is found in certain cereal grain-based flours such as wheat, rye and barley. Principally, the grain of concern is wheat, since it is commonly used to make many food products that are difficult to avoid if one wants to have a so-called typical diet. Wheat is found in many food products, including bread like items, biscuits, cereals and the like.

The art is replete with attempts to make gluten-free products; however, gluten has been difficult to replace while producing food products with similar eating and appearance characteristics. This is primarily because gluten is the protein that principally provides the expected bread like structure, appearance and eating texture of the finished food product. The term “gluten free” means that the product has no gluten, or substantially no gluten, e.g., less than about 20 ppm by weight of the final cooked product.

Gluten is typically referred to as a protein; however, gluten is a mixture of proteins found in wheat and related cereal grains, including barley and rye. Gluten provides elasticity in dough and the ability of a dough to hold leavening gas, helping the dough rise and keep its shape. It also provides a chewy texture in the cooked product. Gluten is a composite of gliadin and glutenin and is conjoined with starch in the grain, and is largely responsible for the viscoelastic properties of hydrated gluten containing flour.

Efforts to date to produce gluten free products have been somewhat successful; however, the replacement of a gluten containing product with a similar product having the same appearance, texture, and structure has been difficult because of the unique nature of gluten.

### DESCRIPTION OF THE PRIOR ART

Examples of attempts to make gluten free products can be found in U.S. Pat. Nos. 7,901,725; 7,947,319; 8,088,427; and 8,685,482; and in U.S. Patent Applications 2010/0119652; 2003/0091715; and 2007/0275121. Other examples can be found.

A typical substitute for gluten is one or more gums. However, the resulting cooked product typically has both texture and flavor problems, reducing their appeal.

### SUMMARY OF THE INVENTION

The present invention utilizes a combination of a slow hydrating hydrocolloid and a fast hydrating hydrocolloid, along with other starch and protein containing ingredients, to produce a batter type, uncooked product that is ultimately cooked to produce a pizza crust or other bread like product.

It is a further objective of the instant invention to provide a finished product precursor that is made from what, following mixing, is a pourable batter which, during subsequent hydration and proofing, transforms into a material with a consistency similar to a wet dough.

It is yet another objective of the instant invention to provide a finished, cooked crust product that is similar in appearance, texture and structure to a typical yeast leavened gluten containing crust.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

The patent or application contains at least one drawing executed in color. Copies of this patent or patent application publication with color drawings will be provided by the Office upon request and payment of the necessary fee.

FIG. 1 is a photograph showing the inventive product and a commercially available gluten free pizza crust (made by Udi) with the inventive product being on the bottom.

FIG. 2 is a graph showing viscosity increase with time for slow and fast acting hydrocolloids.

FIG. 3 is a table showing the consistency of a gluten free batter immediately after mixing, after hydration without proofing, and after hydration and proofing, as compared to a wheat flour based yeast leavened wet dough.

### DETAILED DESCRIPTION OF THE INVENTION

A cooked food product that is useful in making a crust for making pizza and the like is provided. It can also be used for other flatbread type products or rolls. Flatbread type products also include tortillas, pitas and focaccia. The word “crust” will be used herein to denote crusts and other flatbread like products to simplify the disclosure. Such a cooked crust has a large ratio of top surface area to crust thickness. A cooked crust has thickness on the order of ⅛ inch to 1 inch, and would have at least one top surface transverse of at least about 4 inches; and for use in retail sales of finished product in a food store could be up to about 16 inches. Typically, such crusts are generally round and generally planar on the two opposite main surfaces. One or more topping materials can ultimately be provided on the top surface, and can include such things as a tomato-based sauce, cheese, meat, fruit, vegetables and the like. Such products are typically savory, however, sweet products can be provided too. Generally, the crust has the topping material applied after the crust is at least partially cooked, i.e., enough cooking to set the structure. The finished product is usually frozen and then finish cooked by the consumer, if the product is bought at a food store. However, restaurants can also provide such a product, and can make the crust from scratch or buy a crust from a supplier that is either partially or fully cooked.

A roll would typically have a cooked thickness of about ½ inch up to about 2 inches. They can be round, oval or rectangular. The major transverse dimension is at least about 1.5 inches to about 5 inches. A roll produced as provided for herein is also bread like. It is made like the flatbread items. “Bread like” means the product has texture and taste like bread made from yeast leavened dough, and has a cellular structure.

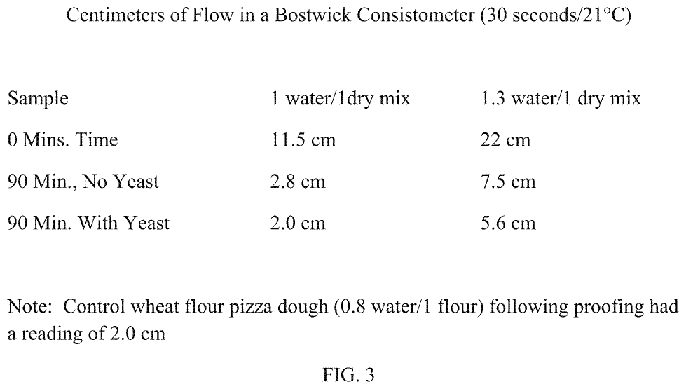

The present invention forms a batter from dry ingredients, leavener and at least one plasticizer. Dry ingredients will typically contain some water as noted below, and are usually in particulate form as is known in the art. The dry ingredients include at least two different hydrocolloids, plus a leavener and plasticizer are mixed to form a flowable batter having a Bostwick Consistometer reading in the range of between about 10 cm and about 24 cm (measured at 30 seconds and 21° C.). Mixing can be accomplished mechanically by a hand mixing device or mechanized power driven mixing device as are known in the art. Mixing is performed until the ingredients form a batter that can be poured into a mold to make a uniform shape, and during leavening, the batter hydrocolloids finish hydrating, wherein the batter has a final consistency that can be described as a wet dough or gel. After mixing, the batter is allowed to leaven (rise), during which time, one of the hydrocolloids effects a substantial change in the viscoelastic properties of the batter. As seen in FIG. 3, both hydration of the hydrocolloids and the action of the yeast fermentation play a role in this change in viscoelastic properties. After rising, the product is cooked in any suitable manner. The mixed batter can be deposited into crust sized or roll sized precursor components, preferably before leavening appreciably occurs, and then allowed to leaven. Cooking can be a complete cooking or a partial cooking as are known in the art. Cooking is preferably accomplished by baking, using air as a heat exchange medium in addition to radiant heat transfer.

The dry ingredients include a fast hydrating hydrocolloid, for example, xanthan gum, and a slow hydrating hydrocolloid, for example, psyllium. The fast hydrating hydrocolloid is present in the range of between about 0.1% and about 0.5%, and preferably in the range of between about 0.1% and about 0.3% on a dry weight basis of the dry ingredients. The slow hydrating hydrocolloid is present in the range of between about 0.5% and about 2.5%, and preferably in the range of between about 1% and about 2% on a dry weight basis of the dry ingredients. The ratio of fast acting hydrocolloid to slow acting hydrocolloid is in the range of about 0.01:1 to about 0.5:1, and preferably in the range of between about 0.05:1 and about 0.15:1 on a dry weight basis.

A fast hydrating hydrocolloid is a hydrocolloid that will reach 50% of peak viscosity within about 15 minutes or less of mixing with water as measured with a USS-DVT4 viscometer using conditions of spindle #4, 30 rpm's and a temperature of 70° F. A slow hydrating hydrocolloid is a hydrocolloid that will reach 50% of peak viscosity within about 90 or more minutes of mixing with water as measured with a USS-DVT4 viscometer using conditions of spindle #4, 30 rpm's and a temperature of 70° F. The test product is water plus hydrocolloid, with the hydrocolloid being present on a dry weight basis in an amount of 1% by total weight of the mixture of hydrocolloid and water. Dispersion of the hydrocolloid can be facilitated by blending sucrose with the hydrocolloid, e.g., 3% by weight sucrose on a dry weight basis of the dry ingredients. FIG. 2 illustrates viscosity increase with time for a fast and a slow hydrating hydrocolloid.

The dry ingredients also include starch and protein and other ingredients. Of the dry ingredients, the starch and protein combined would be on the order of about 90-95% by weight of dry ingredients on a dry weight basis. The above-mentioned hydrocolloids combined would be the remainder of the dry ingredients, and are in the range of between about 0.6% and about 3%, and preferably in the range of between about 1.5% and about 2.5% on a dry weight basis. The weight ratio of the starch to protein is in the range of between about 8:1 and about 22:1, and preferably in the range of between about 12:1 and about 18:1 on a dry weight basis. In a preferred embodiment, the starch containing components can be provided by potato starch, tapioca, corn flour and sweet white sorghum flour. The added protein, that protein that is not part of the starch containing components, is preferably added in the range of between about 3% and about 10%, and preferably in the range of between about 5% and about 7% of the dry ingredients on a dry weight basis. Suitable added proteins include whey protein, whey protein isolate, egg albumin and vegetable protein, such as pea protein. A carbohydrate which can be fermented by yeast (e.g., glucose and/or sucrose) can also be used, as, unlike wheat flour, most gluten free starches do not contain a significant amount of fermentable carbohydrates. The added fermentable carbohydrate is in the range of between about 0.5% and about 5%, and preferably in the range of between about 1% and about 3% of the dry ingredients on a dry weight basis.

Other dry ingredients can include such things as herbs, spices and salt, which combined would be present in the range of between about 0.3% and about 3%, and preferably in the range of between about 0.5% and about 1.5% of the dry ingredients on a dry weight basis.

A leavener is provided, and is preferably yeast. It is to be understood, though, that one or more chemical leaveners can be provided to supplement or replace a yeast leavener. Yeast can be either fresh or dry. If dry, it is added in an amount in the range of between about 0.3% and about 3%, and preferably in the range of between about 1% and about 2% on a dry weight basis of the dry ingredients. Fresh yeast can also be added, and would be present in an amount approximately 3 times that of dry yeast. It is pointed out that fresh yeast is dry yeast with added water that, on a dry weight of yeast, has the same amount of yeast as the dry yeast listed above.

At least one plasticizer is provided in an amount sufficient to form the dry ingredients and leavener into a batter that, after mixing and proofing, will preferably form a wet dough/gel. The plasticizer includes principally water. Water is added such that the total water (added water plus water in the dry ingredients and leavener) is present in the range of between about 80% and about 150%, and preferably in the range of between about 100% and about 130% of the weight of dry ingredients. If desired, lipids can also be provided in the range of between about 0% and about 5%, and preferably in the range of between about 0% and about 2% on a dry weight basis of the dry ingredients.

It is to be understood that particulates can be added to the crust in a manner to be bound therein. Such particulates can include cheese pieces, meat pieces, vegetable pieces and the like. Preferably, they are added at a time so they do not move through the batter or wet dough/gel to be exposed on the product bottom (as the product is positioned for cooking). They can be encapsulated in the batter or wet dough/gel or have a portion exposed on the top side. They can be added after the batter thickens or is in the form of a wet dough/gel that will allow the desired amount of penetration, if any, prior to finishing cooking.

The formation of a crust (or roll) can be accomplished as follows. The dry ingredients, leavener and plasticizer are mixed mechanically to form an initial batter. Preferably, the batter is deposited in a mold to form an outer perimeter shape, if desired, to form a crust precursor that is then allowed to rise under the influence of gas produced by the leavener, such as yeast. During this rising, hydration continues at least in some of the dry components. During rising, the specific volume of the initial batter increases at least about 50%, and preferably at least about 100%. This proofing/hydration step typically takes on the order of 30-90 minutes, during which the specific volume of the batter/wet dough-gel increases from about 1.0 cc/gm to about 2.0 cc/gm (a 100% increase). The consistency of the initial batter and proofed precursor just prior to cooking can be measured by a Bostwick Consistometer. The consistency of the initial batter is in the range of between about 10 cm and about 24 cm, and preferably in the range of between about 12 cm and about 22 cm measured under conditions—30 seconds of flow at 70° F. The consistency of the proofed precursor just prior to cooking is in the range of between about 1 cm and about 8 cm, and preferably in the range of between about 2 cm and about 6 cm measured under conditions of 30 seconds of flow at 70° F. The proofed precursor preferably has a consistency of a wet dough-gel. The crust precursors are then cooked, preferably by baking. Baking can be at a temperature in the range of between about 350° F. and about 550° F. until the desired amount of cooking has been accomplished. This can take on the order of 3 to 20 minutes. The cooked crust product has a thickness of less than about 1 inch, and preferably less than about ¾ inch, exclusive of any peripheral lip thickness. The cooked product thickness is in excess of about ⅛ inch, and preferably in excess of about ¼ inch. The cooked product has its major transverse dimension in the range of between about 4 inches and about 16 inches. In the case of a round crust, the major cross sectional dimension would be its diameter. The dimensions for a roll are described above. The baked specific volume of the crust or roll is between about 1.5 cc/gm, and about 3.5 cc/gm, and preferably is in the range of between about 2 cc/gm and about 3 cc/gm. The baked specific volume is a function of the specific volume of the wet dough/gel and the added protein type and concentration. Generally, the higher the protein concentration, the higher the baked specific volume.

The process includes mixing the dry ingredients, leavener and plasticizer. A batter having the above mentioned consistency is initially formed. The batter is then deposited, preferably in a mold that constrains sideways flow, and forms the outer edge of the precursor component. The precursor is allowed to leaven at room temperature or in a proofing oven until the specific volume expands, preferably doubles as described above. During proofing, the slow acting hydrocolloid and yeast fermentation function to turn the batter into what can be called a wet dough/gel. This allows the proofed batter to retain leavening gas and form a bread like cooked product having a specific volume in the range of between about 1.5 cc/gm, and about 3.5 cc/gm. The proofed product is then cooked as described above. Surprisingly, the cooked product looks, chews and tastes like it was made with wheat based dough, not a batter. The final cooked product has a baked specific volume as described above. It contains starch in the range of between about 80% and about 92%, total water in the range of between about 40% and about 60%, protein in the range of between about 3% and about 10%, and total hydrocolloids in the range of between about 1% and about 3% based on the dry weight of starch, protein and hydrocolloids. It contains a slow acting hydrocolloid and a fast acting hydrocolloid. The fast hydrating hydrocolloid is present in the range of between about 0.1% and about 0.5%, and preferably in the range of between about 0.1% and about 0.3% on a dry weight basis of the dry ingredients. The slow hydrating hydrocolloid is present in the range of between about 0.5% and about 2.5%, and preferably in the range of between about 1% and about 2% on a dry weight basis of the dry ingredients.

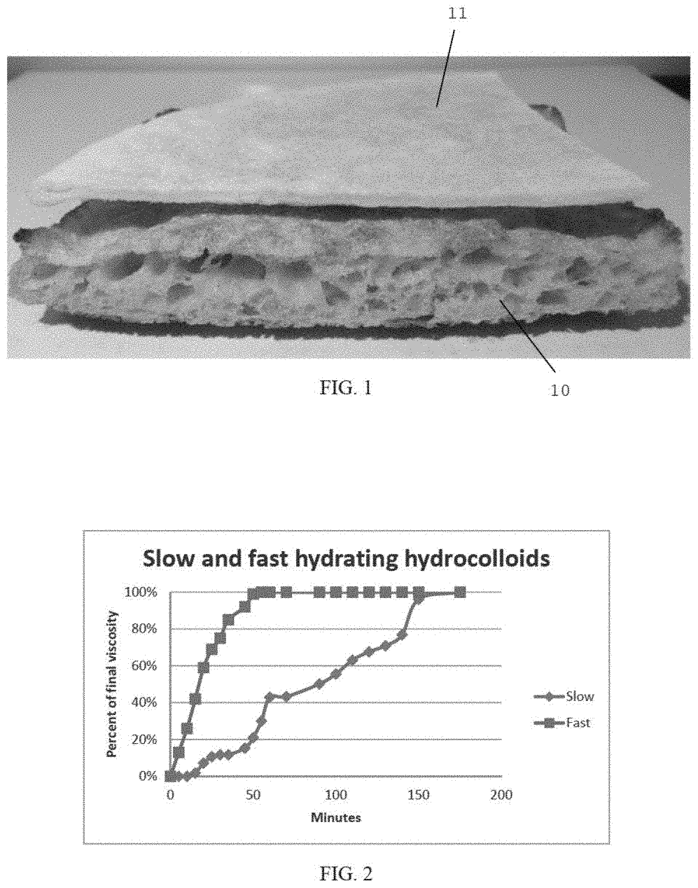

FIG. 1 shows an inventive gluten free crust, designated 10, and a commercially available gluten free crust, designated 11. The inventive crust looks like a normally produced gluten containing crust having a cellular structure with largely disparate cell sizes. The commercial crust looks non bread like. Cooked rolls are similar in properties.

It is to be understood that while certain forms of the invention are illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method of making a substantially gluten free flatbread or roll bread like product, the method comprising:
forming a mixture of dry ingredients including starch, protein, leavener, and a plurality of hydrocolloids including at least two different hydrocolloids, said mixture containing less than about 20 ppm gluten by weight of said dry ingredients on a dry weight basis (with leavener and plasticizer, said dry ingredients being substantially gluten free and including a plurality of hydrocolloids), said hydrocolloids including a fast hydrating hydrocolloid that will reach 50% of peak viscosity within about 15 minutes or less of mixing with water as measured with a USS-DVT4 viscometer using conditions of spindle #4, 30 rpm's and a temperature of 70° F. and a slow hydrating hydrocolloid that will reach 50% of peak viscosity within about 90 or more minutes of mixing with water as measured with a USS-DVT4 viscometer using conditions of spindle #4, 30 rpm's and a temperature of 70° F., (plasticizer, starch, and protein) said hydrocolloids being present in a total amount in the range of between about 0.6% and about 3% by weight of said dry ingredients on a dry weight basis, said leavener including yeast in an amount of at least about 0.3% by weight of said dry ingredients on a dry weight basis and the mixture including plasticizer including water wherein total water is present in an amount in the range of between about 80% and about 150% by weight of said dry ingredients on a dry weight basis, said mixture initially being a batter after initially mixing;
depositing the batter after formation thereof and thereafter forming a (bread) dough like product precursor from the batter;
proofing at least the deposited batter; and
cooking the precursor to form at least a partially cooked bread like item.

2. The method of claim 1 wherein the batter being deposited in a mold.

3. The method of claim 2 wherein the batter is proofed in the mold.

4. The method of claim 3 wherein the cooked product having a thickness in the range of between about ⅛ inch and about 1 inch and having a major top surface transverse dimension of at least about 4′.

5. The method of claim 3 wherein the cooked product having a thickness in the range of between about ½ inch and about 2 inches and having a major top surface transverse dimension of between about 1½ inch and about 5 inches.

6. The method of claim 1 wherein the dry ingredients including starch and protein with a combined weight being in the range of between about 90% and about 95% by weight of dry ingredients on a dry weight basis, and with the weight ratio of the starch to protein being in the range of between about 8:1 and about 22:1 on a dry weight basis.

7. The method of claim 1 wherein the dry ingredients include at least one fermentable carbohydrate in the range of between about 0.5% and about 5%, of the dry ingredients on a dry weight basis.

8. The method of claim 7 wherein the consistency of the initial batter is in the range of between about 10 cm and about 24 cm, and the consistency of the proofed precursor just prior to cooking is in the range of between about 1 cm and about 8 cm.

9. The method of claim 8 wherein the cooked product having thickness in the range of between about ⅛″ and about 1″ and a major transverse dimension of at least about 4″.

10. The method of claim 8 wherein the cooked product having thickness of at least about ½ inch and a major transverse dimension of at least about 1½ inches.
